(19) United States
(12) Patent Application Publication
(10) Pub. No.: US 2005/0227557 A1
(43) Pub. Date: Oct. 13, 2005

(54) Method of making fabric with photo-catalyst

(76) Inventor: Li Lin, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/819,911

(22) Filed: Apr. 8, 2004

(51) Int. Cl. B32B 5/02

(52) U.S. Cl. 442/59; 428/292.1

(57) ABSTRACT

A method of making fabric with photo-catalyst comprises providing a length of fabric, cleansing the fabric by eliminating miscellaneous articles, applying a photo-catalyst solution to the fabric by immersion, and then eliminating the surplus photo-catalyst solution. The fabric is dried to solidify the photo-catalyst on the fabric. The fabric consequently has functions of sterilizing, deodorizing, self-cleaning, and anti-mildew when exposed to light.

### BACKGROUND OF THE INVENTION

1. Field of the Invention

The present invention relates to a method of making fabric with a photo-catalyst, and particularly to a method for applying the photo-catalyst to a fabric.

2. Description of the Prior Art

Referring to FIG. 1, a perspective view of a fiber having photo-catalyst is shown. For applying a photo-catalyst to a fabric, the manufacturing steps of conventional technology are spinning fibers with photo-catalyst into yarn and then weaving a fabric from the yarn. The photo-catalyst 10a is first added to a macromolecule solution. The macromolecule solution with the photo-catalyst is then squeezed via spinning mouths, and dried by heat to form a fiber 20a. Therefore, the fabric has the functions of sterilizing and deodorizing via the photo-catalyst thereon.

However the manufacturing method of making fabric with photo-catalyst has the disadvantages as follows:

1. The photo-catalyst corpuscles added in the macromolecule solution has cohesive force, so the photo-catalyst corpuscles are not well mixed and dispersed. Because the macromolecule solution has a higher viscosity, the photo-catalyst corpuscles are poorly dispersed, which is affecting the arrangement and extrusion of fibers and the dispersion of the photo-catalyst, so that the fibers are easily interrupted while reeling.

2. The manufacturing method of adding the photo-catalyst into the macromolecule solution is only suitable for synthetic fibers, and not suitable for application on natural fibers.

3. The fibers of the conventional manufacturing method have low stretchability, which affects the yarn and the subsequent weaving processes. The output is reduced and the production cost is increased.

### SUMMARY OF THE INVENTION

An object of the present invention is to provide a method of making fabric with a photo-catalyst, and in particular to a simple manufacturing method for applying the photo-catalyst to a fabric, so that the fabric has functions of sterilizing, deodorizing, self-cleaning, and anti-mildew when exposed to light.

In order to achieve the above objects, the present invention according to one aspect thereof provides a method of making fabric with photo-catalyst comprising the following steps. A length of fabric is provided and cleansed with a water solution. The solution on the fabric is dehydrated to eliminate miscellaneous articles. A photo-catalyst solution is provided and applied to the fabric by soaking the fabric therein. Surplus photo-catalyst solution is eliminated and the fabric is dried to solidify the photo-catalyst on the fabric. The photo-catalytic solution applied to a fabric comprises titania powder, acetone, resin and water.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of a fiber having photo-catalyst of the prior art; and

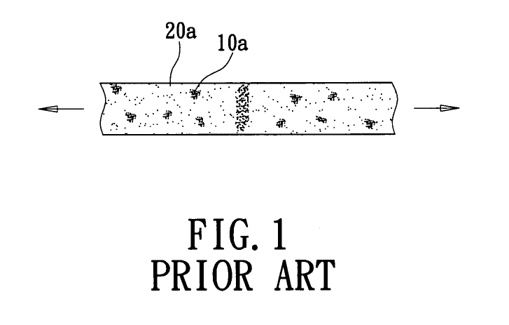

FIG. 2 is a flow chart describing the process of making fabric with photo-catalyst according to the present invention.

### DESCRIPTION OF THE PREFERRED EMBODIMENT

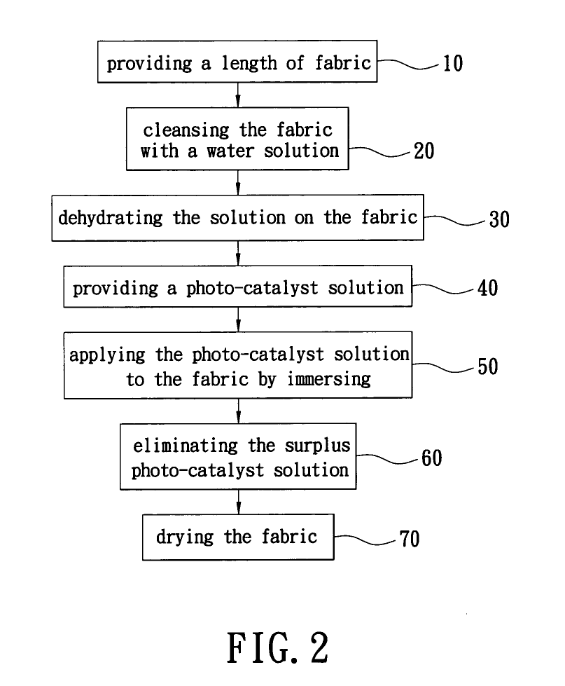

Reference is made to FIG. 2, which is a flow chart describing the process of making fabric with photo-catalyst according to the present invention. The present invention provides a method for applying photo-catalyst to a fabric, so that a layer of photo-catalyst on is adhered to a surface of a fabric and the fabric consequently has functions of sterilizing, deodorizing, self-cleaning, and anti-mildew.

In the first step 10 is to provide a length of fabric 10. The fabric 10 can be a fabric of any kinds of fibers. Before applying the photo-catalyst on the fabric 10, the fabric 10 must be cleansed beforehand to eliminate miscellaneous articles, such as, for example, greasy dirt, sizing material, or impurities. This prevents miscellaneous articles on the fabric from affecting solidification of the photo-catalyst on the fabric.

The next step 20 is to utilize a water solution to cleanse the fabric. In this step, the fabric is immersed in a water solution containing a nonphosphorous detergent without heavy metals at 20-80 degrees centigrade and the water solution is stirred to promote the cleansing action thereof. Then, in step 30, the solution on the fabric is dehydrated to eliminate miscellaneous articles, and the steps of cleansing the fabric and dehydrating the solution are preferably repeated for a more thorough cleansing of the fabric. Step 30 of cleansing the fabric with a water solution further comprises a step of purging impurities and detergent via water.

The following step 40 is providing a photo-catalyst solution and immersing the fabric in the photo-catalyst solution. The photo-catalyst solution is stirred for 3 to 15 minutes, at which point the fabric is immersed in the photo-catalyst solution. Step 50 is the continuous application of the photo-catalyst solution to the fabric; the photo-catalyst solution soaks in between the fibers of the fabric and adheres onto the fibers. In step 60, the surplus photo-catalyst solution is eliminated. Finally, in step 70, the fabric is dried to remove moisture from the fabric and solidify the photo-catalyst on the fabric. The fabric is dried by, for example, heat setting, baking, or drying in the shade. The temperature of heat setting is below 150 degrees centigrade.

For even solidification of the photo-catalyst on the fabric, the photo-catalytic solution applied to the fabric must comprise a binder and a solvent. The photo-catalyst solution comprises about 0.1 to 10 weight percent titania powder, about 1 to 5 weight percent acetone solution, and about 2 to 10 weight percent resin based on the photo-catalyst solution, and the remainder is water.

The present invention provides a simple manufacturing method for applying the photo-catalyst to a fabric, so that the fabric has functions of sterilizing, deodorizing, self-cleaning, and anti-mildew when exposed to light.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

1. A method of making fabric with photo-catalyst, comprising the steps of:
providing a length of fabric;
cleansing the fabric with a water solution;
dehydrating the water solution on the fabric to eliminate miscellaneous articles;
providing photo-catalyst solution;
applying the photo-catalyst solution to the fabric by immersion;
eliminating surplus photo-catalyst solution; and
drying the fabric to solidify the photo-catalyst on the fabric.

2. The method of making fabric with photo-catalyst as in claim 1, wherein a temperature of the water solution for cleansing the fabric is about 20 to 80 degrees centigrade.

3. The method of making fabric with photo-catalyst as in claim 1, further comprising a step of stirring the photo-catalyst solution, when immersing the fabric in the photo-catalyst solution.

4. The method of making fabric with photo-catalyst as in claim 3, wherein the photo-catalyst solution is stirred for about 3 to 15 minutes.

5. The method of making fabric with photo-catalyst as in claim 1, wherein the fabric is dried by heat setting.

6. The method of making fabric with photo-catalyst as in claim 1, wherein the fabric is dried by baking.

7. The method of making fabric with photo-catalyst as in claim 1, wherein the fabric is dried in shade.

8. The method of making fabric with photo-catalyst as in claim 1, wherein the photo-catalyst solution comprises about 0.1 to 10 weight percent titania powder, about 1 to 5 weight percent acetone solution, and about 2 to 10 weight percent resin based on the photo-catalyst solution, with a remainder being water.

9. The method of making fabric with photo-catalyst as in claim 1, wherein the water solution for cleansing the fabric comprises a detergent, and wherein the detergent is nonphosphorous and contains no heavy metals.

10. The method of making fabric with photo-catalyst as in claim 9, wherein the step of cleansing the fabric with a water solution further comprises a step of purging impurities and detergent with water.

11. The method of making fabric with photo-catalyst as in claim 1, further comprising a step of repeating the steps of cleansing the fabric and dehydrating the solution to eliminate miscellaneous articles on the fabric.

12. A photo-catalytic solution applied to a fabric, comprising
titania powder, acetone, resin and water.

13. The photo-catalytic solution applied to a fabric as in claim 12, wherein the titania powder is about 0.1 to 10% by weight based on the photo-catalyst solution.

14. The photo-catalytic solution applied to a fabric as in claim 12, wherein the acetone is about 1 to 5% by weight based on the photo-catalyst solution.

15. The photo-catalytic solution applied to a fabric as in claim 12, wherein the resin is about 2 to 10% by weight based on the photo-catalyst solution.

16. The photo-catalytic solution applied to a fabric as in claim 12, wherein the water is about 75 to 96.9% by weight based on the photo-catalyst solution.
